(19) United States
(12) Patent Application Publication
(10) Pub. No.: US 2025/0238853 A1
(43) Pub. Date: Jul. 24, 2025

(54) AI-POWERED MEDIA ANALYSIS FOR ITEM RECOGNITION

(71) Applicant: TOSHIBA GLOBAL COMMERCE SOLUTIONS, INC., Durham, NC (US)

(72) Inventors: Samuel C. CHAMPAGNE, Raleigh, NC (US); Brian D. TAYLOR, Durham, NC (US); Kirk GOLDMAN, Cary, NC (US); Manda MILLER, Raleigh, NC (US); Theodore R. CLARK, Allendale, NJ (US); Kristen M. CHUNG, Cornelius, NC (US); Pawita SUNTHORNPONG, Chapel Hill, NC (US)

(21) Appl. No.: 18/416,810

(22) Filed: Jan. 18, 2024

(51) Int. Cl. G06Q 30/0601; G06Q 10/087; G06V 10/82

(52) U.S. Cl. CPC G06Q 30/0639; G06Q 10/087; G06V 10/82

(57) ABSTRACT

Techniques for media processing and item recognition are provided. A digital media is received from a user. Objects depicted within the digital media are identified. Items currently available at a physical location are determined by analyzing information collected by a set of cameras at the physical location. A set of target items, from the items currently available at the physical location, that are similar to at least one of the objects are identified based on the digital media and the collected information. A guidance that navigates the user to at least one of the set of target items within the physical location is generated.

### BACKGROUND

Social media platforms have become increasingly popular for promoting and advertising products. Social media posts designed for these purposes often include a variety of visual media, such as images, videos, and motion graphics, to display different perspectives of the promoted products. While these posts primarily serve as digital advertisements, some are integrated with e-commerce features, which allow viewers to directly purchase the products displayed online. When such an e-commerce option is activated, for example, an automated purchase window may pop up at the end of a video, which guides the viewers to purchase the featured items. This system streamlines the online transactions in a manner that customers can complete their purchases with a single click. Nevertheless, despite the convenience of online shopping, many customers still value the tangible benefits offered by offline shopping, which allows them to physically touch and inspect a product, receive immediate assistance from salespeople, and purchase the product with no additional shipping cost. Such preferences often drive customers to physical stores after seeing a product online. These customers, after viewing the online posts, may drive to a physical store and try to find the promoted products or anything similar within the store.

### BRIEF DESCRIPTION OF THE DRAWINGS

FIG. 1 depicts an example environment in which embodiments of the present disclosure may be implemented.

FIG. 2 depicts an example of workflow for item recognition and guidance route generation, according to some embodiments of the present disclosure.

FIG. 3 depicts an example method for media data processing and inventory searching, according to some embodiments of the present disclosure.

FIG. 4 depicts an example method for similarity matching, according to some embodiments of the present disclosure.

FIG. 5 depicts an example method for alert generation, according to some embodiments of the present disclosure.

FIG. 6 is a flow diagram depicting an example method for identifying in-store items similar to featured objects in digital media and generating a corresponding guidance route, according to some embodiments of the present disclosure.

FIG. 7 depicts an example computing device for item recognition and guidance route generation, according to some embodiments of the present disclosure.

To facilitate understanding, identical reference numerals have been used, where possible, to designate identical elements that are common to the figures. It is contemplated that elements disclosed in one embodiment may be beneficially used in other embodiments without recitation.

### DETAILED DESCRIPTION

Social media and other online platforms have become powerful tools for product promotion, often integrating e-commerce features to facilitate online shopping directly from digital posts. However, for customers who prefer offline shopping, a challenge arise, especially when they see products promoted on social media and wish to purchase them in physical stores. This is because current retail setups typically lack a streamlined mechanism for customers to quickly identify items they have seen in online posts and then locate these promoted products within a physical store. The gap between online discovery and offline purchasing leads to a suboptimal consumer experience and potentially reduces sales opportunities for retailers.

Embodiments of the present disclosure provide methods and techniques for enhancing retail shopping experience by integrating online product discovery with in-store experience. In some embodiments, the disclosed techniques include extracting and identifying products shown in various forms of digital media (e.g., images or videos within social media posts), searching a store's inventory for similar or matching products, and generating guidance routes that direct customers to the locations of these identified similar or matching products in the store. As used herein, “digital media” may refer to an image, a video, a three-dimensional model, a motion graphic, or any other form of visual representation that displays an item or product to potential consumers. As used herein, “in-store inventory” may refer to a collection of items available for purchase within the physical premises of a store or other physical location where items can be purchased. In some embodiments, the in-store inventory may include a catalog of the available items, along with their categories, sizes, quantities, and other associated information. In some embodiments, the in-store inventory may be determined at least partially using cameras installed within the store. These in-store cameras may capture visual data of the products available at the store. The visual data may then be processed by advanced Al-based algorithms to recognize the products and their relevant attributes, such as size, color, and quantity, which can be used to for further item matching and searches.

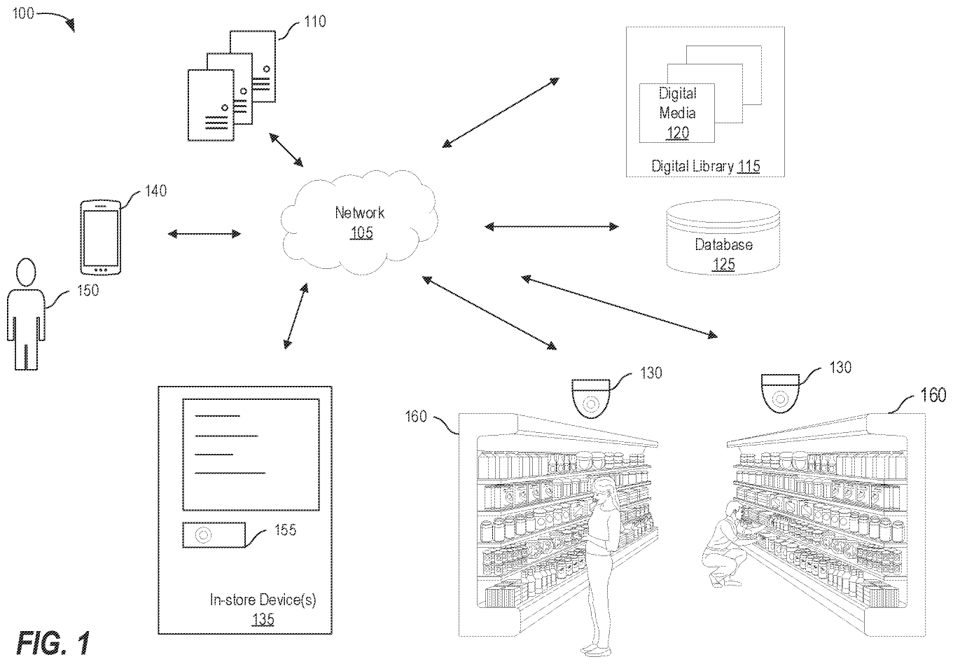

FIG. 1 depicts an example environment 100 in which embodiments of the present disclosure may be implemented. In the illustrated example, the environment 100 includes one or more servers 110, a digital library 115, a database 125, one or more in-store cameras 130, one or more in-store devices 135, and one or more end user devices 140. In some embodiments, one or more of the illustrated devices may be a physical device or system. In other embodiments, one or more of the illustrated devices may be implemented using virtual devices, and/or across a number of devices.

In the illustrated example, the one or more servers 110, the digital library 115, the database 125, the one or more in-store cameras 130, the one or more in-store devices 135, and the one or more end user devices 140 are remote from each other and communicatively coupled to each other via a network 105. That is, the one or more servers 110, the digital library 115, the database 125, the one or more in-store cameras, the one or more in-store devices 135, and the one or more end user devices 140 may each be implemented using discrete hardware systems. The network 105 may include or correspond to a wide area network (WAN), a local area network (LAN), the Internet, an intranet, or any combination of suitable communication medium that may be available, and may include wired, wireless, or a combination of wired and wireless links. In some embodiments, the servers 110, the database 125, the in-store device 135, and the in-store cameras 130 may be local to each other (e.g., within the same local network and/or the same hardware system), and communicate with one another using any appropriate local communication medium, such as a local area network (LAN) (including a wireless local area network (WLAN)), hardwire, wireless link, or intranet, etc.

In the illustrated example, the digital library 115 comprises a plurality of digital media 120 posted online that display, promote, or otherwise depict various items. In some embodiments, the digital media 120 may include a variety of formats of data, including but not limited to images, videos, motion graphics, three-dimensional (3D) models, and animations. In some embodiments, the digital media 120 may serve as visual representations that provide details on the design, functionality, and usability of the products. In some embodiments, the digital media 120 may further comprise textual data (e.g., headlines, product descriptions, and customer reviews), to provide additional context or clarity regarding the products. In some embodiments, an end user 150 (also referred to in some embodiments as a customer) may access, edit, download, and/or upload digital media 120 to the digital library via the end user device 140. In some embodiments, the digital library 115 may be a static repository. In some embodiments, the digital library 115 may function as a dynamic platform that updates based on various factors. For example, the library 115 may continuously update with content (e.g., user-generated social media posts including digital media) to reflect the user's preferences or the latest trends. In some embodiments, some advanced search functionalities may be integrated into the digital library 115. These search functions, powered by Al-based models, may efficiently process queries to understand a user's intent and preference. Based on this understanding, future searches may be predicted. In some embodiments, the digital library 115 may interface with recommendation systems, to push customized content to a user device 140 based on a user's browsing habits, preferences, or purchase history. In some aspects, the digital library 115 corresponds to one or more social media platforms.

In the illustrated example, end users 150 (also referred to in some embodiments as customers) can stream, view, edit, upload and/or download the digital media 120 directly on their devices 140. In some embodiments, when end users or customers 150 enter a merchant location, such as a store, they may scan the digital media 120, displayed on their personal devices 140, to an in-store device 135 (e.g., a kiosk station). As used herein, “scan” may refer to the process of directly capturing or recording the media (e.g., images or videos) displayed on the user's device. In order to achieve this, the in-store device 135 may be installed with a high-resolution camera 155 that can take an image or video of the content displayed on the user's device 140.

For example, the end user 150 may ensure that the item(s) they are interested in are visible or being displayed on their device 140 (e.g., playing a relevant section of the video, pausing the video at the right point, or outputting an image of the item(s)). The end user 150 may then place their user device 140 on or against a clear (e.g., glass) surface with a camera 155 positioned behind or beneath the surface to capture image(s) or video of the content being displayed on the user device 140. Once scanned, the in-store device 135 may forward the captured digital content (e.g., images or videos) to the server(s) 110 for further processing and analysis (e.g., item recognition, item matching, and guidance route generation). In addition to or instead of scanning via the in-store device 135, several other methods may be used to transmit the digital media 120 to the in-store devices 135. For example, the in-store devices 135 may be configured to support near-field communication (NFC), Bluetooth, and/or Wi-Fi Direct transmissions, through which users may transmit the digital media (or a link to the media in a social media platform, such as the digital library 115) wirelessly to the in-store devices. In some embodiments, the in-store devices 135 may include some direct wired ports, such as UCB-C, to facilitate a direct transfer of the media and/or links between the user devices 140 and the in-store devices 135.

In some embodiments, to provide a more customized experience, end users 150 may be logged into the store's application on their devices 140 when scanning or transmitting the digital media 120 to the in-store device 135. After the application processes the visual data and identifies potential matches (e.g., items currently available within the store that potentially match or are similar to the products featured in the digital media), the application may activate an in-store navigation feature, to guide the end users or customers 150 in real-time to the exact locations of the matching or similar items within the store.

In the illustrated example, the in-store cameras 130 are installed strategically throughout the store. In some embodiments, the in-store cameras 130 may capture detailed visual data of products within the store (e.g., products placed on shelves or racks 160 in the retail and/or storage areas within the store). In some embodiments, the in-store cameras 130 may generate or capture images of these products from various angles, to provide a comprehensive and detailed representation of each product. In some embodiments, the visual data captured by the in-store cameras 130 may be transmitted to a centralized server 110 for further analysis. Upon receiving the visual data, the server 110 may perform item recognition using advanced Al-based algorithms. For example, the server 110 may identify products within the store and determine relevant attributes for the products, such as color, size, brand, quantity, and the like. In some embodiments, in-store cameras 130 with built-in analytical capacities may be used. In such configurations, the in-store cameras 130 may process visual data to extract features, and forward the refined information to the server 110. Based on the refined information, the server 110 may perform advanced analysis to identify items that are currently available at the store. Following the item recognition, the server 110 may generate an updated in-store inventory, which may provide customers 150 and/or staff with real-time visibility into stock levels of the store. In some embodiments, the in-store inventory may be used to identify items within the store that match and/or are similar to those promoted or depicted in digital media 120 (e.g., content included within social media posts). In some embodiments, the in-store inventory, the digital media 120 scanned or transmitted by users or customers 150, and the matching results may be stored in a database 125, to ensure a consistent and retrievable record of product availability, customer searching history, and digital media interactions.

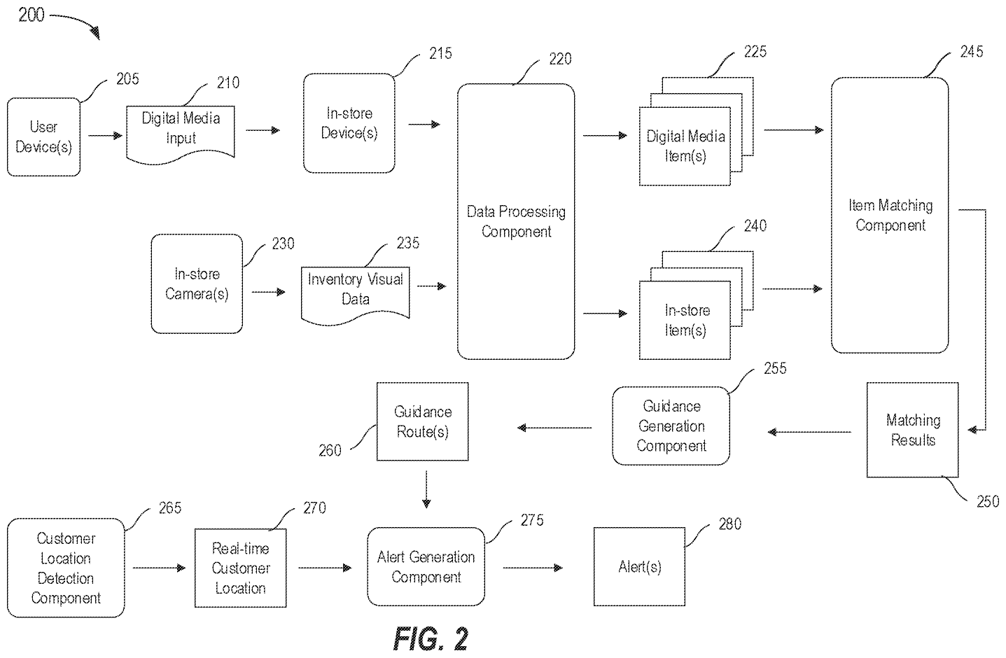

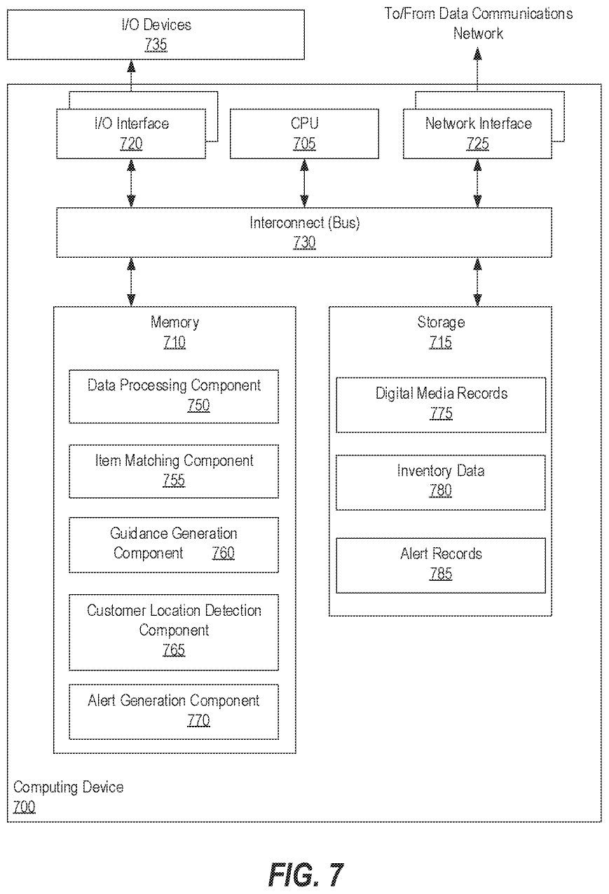

FIG. 2 depicts an example of workflow 200 for item recognition and guidance route generation, according to some embodiments of the present disclosure. In some embodiments, the workflow 200 may be performed by one or more computing systems, such as the server 101, the user device 140, the in-store camera 130, and the in-store device 135 as illustrated in FIG. 1, and/or the computing device 700 as illustrated in FIG. 7.

In the illustrated example, the digital media 210 (e.g., images or videos within social media posts) viewed by customers or end users 150 on their personal device 205 (e.g., a smartphone) (e.g., 140 of FIG. 1) are scanned on or received by the in-store devices 215 (e.g., a kiosk station) (e.g., 135 of FIG. 1), which then forwards the digital media to a data processing component 220.

In the illustrated example, upon receiving the digital media input 210, the data processing component 220 may utilize advanced algorithms to identify items featured within the content. For example, in some embodiments, the data processing component 220 may process the digital media to extract relevant features. This may involve identifying unique patterns, shapes, textures, and/or colors that can differentiate one item from another. After these features are extracted, the data processing component 220 may provide the extracted features to one or more trained machine learning models for the purpose of identifying items displayed within the digital media input 210. Various ML models may be used in this process, including but not limited to random forests, support vector machines, and neural networks (e.g., convolutional neural networks). In some embodiments, the ML model may be trained using images or videos of products as input, and corresponding product labels (e.g., names or categories) as outputs. Through the training, the ML models may learn to correlate the features from the images or videos with the appropriate labels, and may adjust their internal parameters to more accurately predict the labels based on the features. After the training is complete, the models may be validated and/or tested using a separate set of labeled videos or images of products. Through the validation and/or testing process, the models' parameters may be turned and their accuracy may be improved. In some embodiments, customers or end users 150 may provide feedback regarding the accuracy of these items identified or recognized from the digital media input 210. For example, the recognized items may be displayed on either the in-store device (e.g., a kiosk station) (e.g., 135 of FIG. 1) or the user's personal device (e.g., a smartphone) (e.g., 140 of FIG. 1). For each recognized item, the device may display the item's image, name, and possible additional details like price or product description. Below or alongside the recognized item details, the device may provide an option for users to rate the accuracy of the recognition, such as using a star rating (ranging from 1 to 5 stars, where 1 represents dissimilar and 5 represents exact matching) or using a thumb-up button (which represents similar) and thumb-down button (which represents dissimilar). The feedback may then be integrated to further adjust parameters of the models in order to improve item recognition accuracy.

In some embodiments, the data processing component 220 may generate a list of the items 225 recognized from the digital media input (also referred to in some embodiments as digital media items). In some embodiments, when one or more digital media items 225 are identified, the data processing component 220 may generate a detailed profile for each item. The profile may include various attributes of the item, such as its name, color, size, and the like. In some embodiments, the profile may further include contextual information, such as the item's function or its intended purpose. Such detailed profiles for items 225 recognized from digital media input may be used in subsequent item matching, to facilitate efficient identification of in-store items that match or are similar to those viewed by customers online (e.g., on social media platforms) and which they are interested in purchasing in the store.

In the illustrated example, the in-store cameras 230 (e.g., 130 of FIG. 1) actively collect inventory visual data 235, and then transmit the data 235 to the data processing component 220. In some embodiments, the inventory visual data 235 may represent the inventory stock levels of a store. In some embodiments, the inventory visual data 235 may be in the form of images or videos, to capture different attributes or features (e.g., shape, color, size, and quantity) of items within the store. Upon receiving the inventory visual data 235, the data processing component 220 may perform item recognition to identify the available items 240 in the store (also referred to in some embodiments as in-store items), as well as the locations of such items. As discussed above, in some embodiments, the data processing component 220 may extract relevant features that define each item captured within the inventory visual data 235. After extraction, the data processing component 220 may provide the extracted features (along with their corresponding values) to ML models, which are trained to predict product labels (e.g., names or categories) based on the extracted features. In some embodiments, after the in-store items 240 are identified, the data processing component 220 may further generate a profile for each in-store item 240, detailing its size, color, brand, quantity, location, and other relevant features. In some embodiments, based on the identified in-store items 240, the data processing component 220 may generate and/or update the in-store inventory database. In some embodiments, the inventory database may include a comprehensive record of the stock levels within the physical store, with each item's availability, its exact location within the store, and other relevant details being systematically logged.

In the illustrated example, both the digital media items 225 and the in-store items 240 are provided to an item matching component 245. In some embodiments, the item matching component 245 may utilize advanced algorithms to assess similarities between both sets of items. For example, the item matching component 245 may compare the various features of the digital media items 225 with those of the in-store items 240, such as color, shape, design, texture, material, brand, and other unique identifiers. Through the comparison, the item matching component 245 may identify in-store items that match or are similar (visually or functionally) to the digital media items 225 (e.g., these which a customer viewed online). As illustrated, the output of the item matching component 245 is the matching results 250. In some embodiments, the matching results 250 may include a list of in-store items that match or are similar to the items displayed in the digital media input 210. In some embodiments, the matching or similar items may also be referred to as target items. In some embodiments, for each matching or similar in-store item, the matching results 250 may provide additional context information, such as the item's available size or color, its current quantity in stock, and its exact location within the store. In some embodiments, when no in-store item is found to match or be similar to the digital media items, the matching result 250 may include responses indicating no items were found, or that the search yielded no corresponding results. In some embodiments, the matching result 250 may be transmitted to and/or displayed on the user device 205. In some embodiments, the matching result 250 may be transmitted to and/or displayed on the in-store device 215.

In the illustrated example, after the item matching completes, the matching results 250 are then provided to a guidance generation component 255. The guidance generation component 255 is configured to generate guidance routes 260 that direct the customer to the locations of the target items within the store. In some embodiments, the guidance routes 260 may include the store's internal maps, and highlight the shortest or most convenient path for the customer to find each target item (e.g., beginning at a known location where the in-store device 215 is located, and leading to each desired item). The generated guidance routes 260 may then be transmitted to an alert generation component 275. The alert generation component 275 may collect the customer's real-time location data 270 from a customer location detection component 265. By integrating the guidance routes 260 with the customer's real-time location data 270, the alert generation component 275 may track the customer's movements within the store and generate timely alerts 280. For example, in some embodiments, a customer may follow the guidance route 260 to find one of the target items. When the customer is within a predefined proximity (e.g., 10 meters) to the item, the alert generation component 275 may trigger an alert 280 and transmit the alert 280 to the customer's device 205. This mechanism may ensure that every customer who scans the digital media is promptly notified of nearby items of interest, and therefore enhance the customer's in-store shopping experience.

In some embodiments, the matching results 250 may be provided to the end users/customers via either the in-store device(s) 215 (e.g., a kiosk station) (e.g., 135 of FIG. 1) or their personal device(s) 205 (e.g., a smartphone) (e.g., 140 of FIG. 1). By displaying the matching results, it allows the users/customers to review, select, and/or confirm the items they want to be routed to or explore further, and facilitates a more personalized shopping experience.

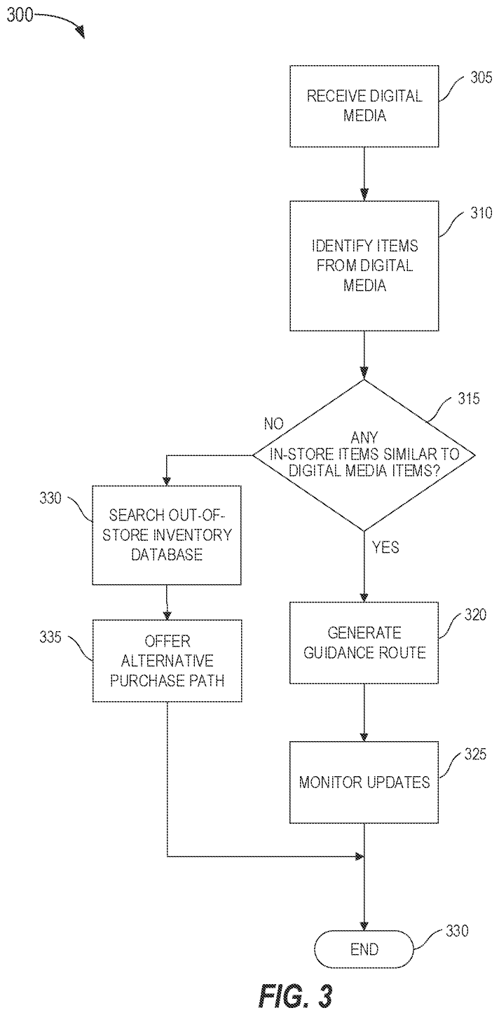

FIG. 3 depicts an example method for media data processing and inventory searching, according to some embodiments of the present disclosure. In some embodiments, the method 300 may be performed by one or more computing devices (e.g., a system that processes visual data and performs inventory searches), such as the server 110 as illustrated in FIG. 1, the data processing component 220, the item matching component 245, and the guidance generation component 255 as illustrated in FIG. 2, and/or the computing device 700 as illustrated in FIG. 7.

The method 300 begins at block 305, where a computing system (e.g., 110 of FIG. 1) receives a digital media input (e.g., 210 of FIG. 2). In some embodiments, the digital media input may include images, videos, graphics, or other media formats from various sources (e.g., social media platforms, online publications, or e-commence websites). In some embodiments, the digital media may serve as promotional material and/or advertisements, created to display one or more products from various perspectives. The digital media may be posted online (e.g., on social media platforms) and offer viewers a visual representation of products that they might be interested in purchasing. Customers or end users, after viewing these media on their personal devices and identifying certain products of interest, may be inclined to explore these products further during their in-store visits. The system may receive the digital media that a customer has previously viewed or shown interest in through a variety of methods. In some embodiments, the system may receive the digital media through in-store devices (e.g., 135 of FIG. 1). For example, in some embodiments, the in-store devices may be configured with scanning capabilities (e.g., a high-resolution camera), through which the in-store devices can quickly record or capture the content within the digital media. In some embodiments, the in-store devices may comprise interfaces (e.g., Bluetooth, NFC, or Wi-Fi Direct) that enable them to receive and/or transmit the digital media content wirelessly. In some embodiments, the system may obtain the digital media through a dedicated application installed on a customer's personal device. After the customer selects, views, or uploads the media of interest within the application, and with the customer's explicit approval, the application may share the digital media directly with the system.

At block 310, the computing system identifies items or objects (e.g., 225 of FIG. 2) displayed within the received digital media. For example, in some embodiments, the computing system may utilize advanced algorithms to process the media data and extract relevant features. These features may include attributes like colors, patterns, textures, shapes, and other unique identifiers that help to determine the nature of the items. In some aspects, such features are extracted using trained machine learning model(s). After these features are extracted and their corresponding values are identified, the data may be provided to a ML model that is trained for item recognition. In some embodiments, the recognized items from the digital media may be displayed on either the in-store device (e.g., a kiosk station) (e.g., 135 of FIG. 1) or the user's personal device (e.g., a smartphone) (e.g., 140 of FIG. 1), asking the user to provide feedback regarding the accuracy of these items. The feedback may then be used to fine-tune the ML models for the purpose of further improving their accuracy and performance.

In some embodiments, besides identifying the products displayed within the digital media, the computing system may further extract contextual information from the media, such as the source URL of the media and/or textual descriptions of the products (e.g., headlines, product descriptions, user feedback). The extracted contextual information may provide additional details about the products, such as their brands, the collections or seasons they belong to, any promotional events or discounts associated with them, and the like.

At block 315, the computing system performs item matching, to identify in-store products that match or are similar to those identified from the digital media. In some embodiments, the real-time availability and stock levels of in-store items may be determined through a network of in-store cameras (e.g., 130 of FIG. 1). These in-store cameras may be configured to capture visual data of products within the store in real time. The collected inventory visual data may then be provided to the system to perform item recognition. As discussed above, the system may use advanced algorithms to extract features from the inventory visual data, and then apply a trained ML model to identify the various items within the store (e.g., 240 of FIG. 2). With the information (e.g., the in-store items), the system may create or update an in-store inventory database. To identify in-store items that match or are similar to the items from the digital media, the system may search through the in-store inventory database, and compare similarities between the extracted features from the digital media and the features of items in the in-store inventory database. If no matching or similar in-store items are found, the method 300 proceeds to block 330.

At block 330, the computing system searches through an out-of-store inventory database. In some embodiments, the out-of-store inventory database may comprise a collection of items that are not currently present in the physical store where the customer is located but are available either in other stores or warehouses, and/or can be purchased from suppliers. At block 335, upon determining that the items matching or similar to those identified from the digital media are available in other stores, the system offers the customer an alternative purchase path. In some embodiments, the alternative purchase path may include options such as online ordering followed by home delivery. In some embodiments, the alternative purchase path may be displayed within a pop-out window that appears on the customer's personal device (e.g., 140 of FIG. 1). In some embodiments, if the customer has scanned or transmitted the digital media to an in-store device (e.g., 135 of FIG. 1), the pop-out window with the alternative purchase options may be displayed on that in-store device. The pop-out window (whether it appears on personal device or in-store device) may ensure that the customer is promptly informed of the available alternative purchase options.

If, at block 315, matching or similar in-store items (also referred to in some embodiments as target items) are identified, the method 300 proceeds to block 320, where the computing system generates guidance routes (e.g., 260 of FIG. 2) for each of the identified in-store items. In some embodiments, after the matching or similar in-store items are identified, their locations within the store may also be determined. Based on the locations and the internal map of the store, the system may create guidance routes. In some embodiments, the guidance routes may provide the customer with the shortest or most convenient pathway to each of the identified in-store items. In some embodiments, the guidance routes may be displayed on the customer's personal devices (e.g., 140 of FIG. 1), directing the customer to find these identified in-store items.

At block 325, the computing system monitors real-time updates to ascertain if any of the identified in-store items (that match or are similar to the products displayed within the digital media) are selected or purchased by another shopper while the customer is approaching the location of the item. In some embodiments, such as when an identified in-store item has limited availability (e.g., a mug cup with a unique pattern that only has one left within the store), the system may (e.g., utilizing in-store cameras) detect that the item has been selected or purchased by another shopper before the customer arrives. In such configurations, the system may update the item's status to “unavailable,” and transmit a notice to the customer's personal devices (e.g., 140 of FIG. 1). The notice may alert the customer about the change in item availability. In some embodiments, the system may provide suggestions for potential alternative items or other similar products available within the store. In some embodiments, the system may updates the guidance routes based on the detected changes. The method then proceeds to block 330, where the item recognition and matching process ends.

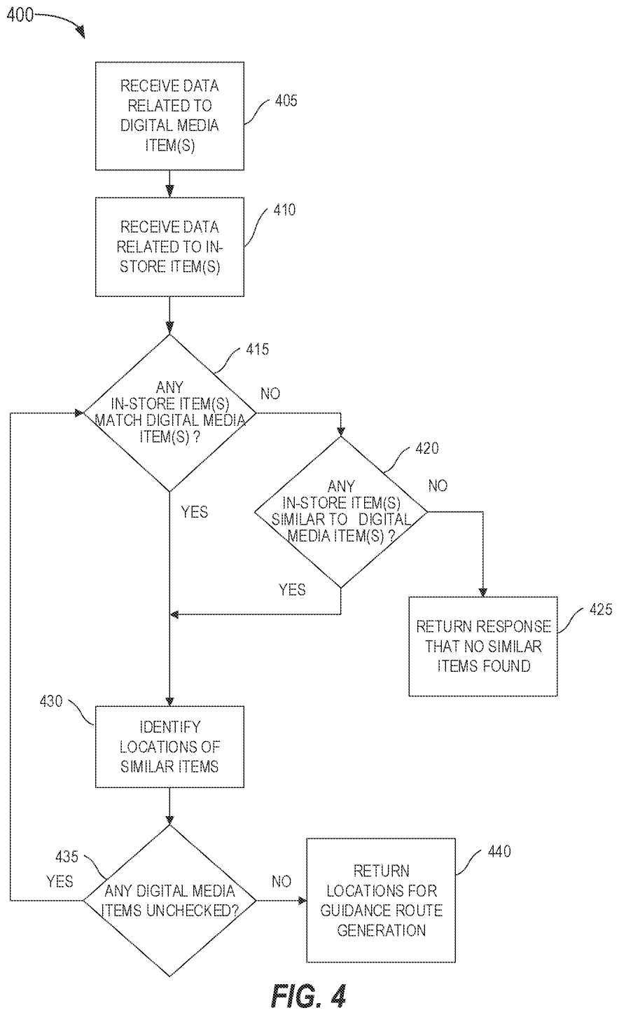

FIG. 4 depicts an example method 400 for similarity matching, according to some embodiments of the present disclosure. In some embodiments, the method 400 may be performed by one or more computing devices, such as the server 110 as illustrated in FIG. 1, the item matching component 245 as illustrated in FIG. 2, and/or the computing device 700 as illustrated in FIG. 7.

At block 405, a computing system (e.g., 245 of FIG. 2) receives data related to items (e.g., 225 of FIG. 2) identified from a digital media input (e.g., 210 of FIG. 2). For each identified digital media item, the data may include features, attributes, and/or descriptions that reflect the nature and characteristics of the item. The data may then be used to compare and match the identified digital media items with those available in a physical store.

At block 410, the computing system receives data related to items (e.g., 240 of FIG. 2) currently available within the physical store. The data may include features, attributes, and/or descriptions of the in-store items, and may be used for subsequent comparison and matching with the digital media items.

At block 415, the computing system assesses the similarity between the digital media items (e.g., 225 of FIG. 2) and the in-store items (e.g., 240 of FIG. 2). In some embodiments, the assessment may include determining whether any in-store items match the digital media items. In some embodiments, to determine the match, the system may compare the features, attributes, and/or description of the items identified from the digital media with those of the in-store items. If an exact match is determined, such as when an in-store item is found to be identical to one of the digital media items, the method proceeds to block 430. If no exact match is identified, such as when no in-store item is found to be identical to any of the digital media items, the method 400 proceeds to block 420.

At block 420, the computing system evaluates if any in-store item is similar to the digital media items. In some embodiments, each item (either the in-store items or the digital media items) may be represented by a feature vector. To determine similarity, the system may compute various metrics, such as cosine similarity, Euclidean distance, between these vectors. In some embodiments, the computing system may establish certain similarity criteria, and when the computed similarity has satisfied these criteria, two items may be considered similar. For example, when calculating cosine similarity, where a value of 0 indicates completely dissimilar and a value of 1 indicates completely similar, the computing system may set up a similarity threshold. If the cosine similarity between two items exceeds the defined threshold (e.g., 0.85), the system may determine that the two items are similar. In some embodiments, the computing system may focus on comparing similarity on functionality, such as whether an in-store item is functionally similar to one of the digital media items. In such configurations, feature vectors may be generated with attributes associated with the item's functionalities, such as utility, purpose, user reviews, manufacturer descriptions, or any feature inherent to the product category. In some embodiments, the system may determine visual similarity, such as whether an in-store item is visually similar to one of the digital media items. For such evaluations, feature vectors may be generated with attributes reflecting the item's visual characteristics, such as color, shape, texture, patterns, and the like. By comparing these feature vectors, the system may determine how visually similar between one in-store item and one digital media item. If a similarity is identified, such as when an in-store item is determined to be similar (either functionally or visually) to the digital media items, the method 400 proceeds to block 430. If no such similarity is identified, such as the calculated similarities between in-store items and digital media items do not meet the similarity criteria, the method 400 proceeds to block 425, where the computing system returns a response indicating the lack of matching or similar items within the store.

At block 430, the computing system identifies the locations of the in-store items that match or are similar to the digital media items.

At block 435, the computing system assesses if any digital media item remain unchecked. If such items are found, the method 400 returns to block 415 to reiterate the matching and comparison processes. However, if all digital media items have been addressed, the method 400 proceeds to block 440, where the system generates a response that includes the locations of the identified in-store items, and provide the response to the generation of guidance routes.

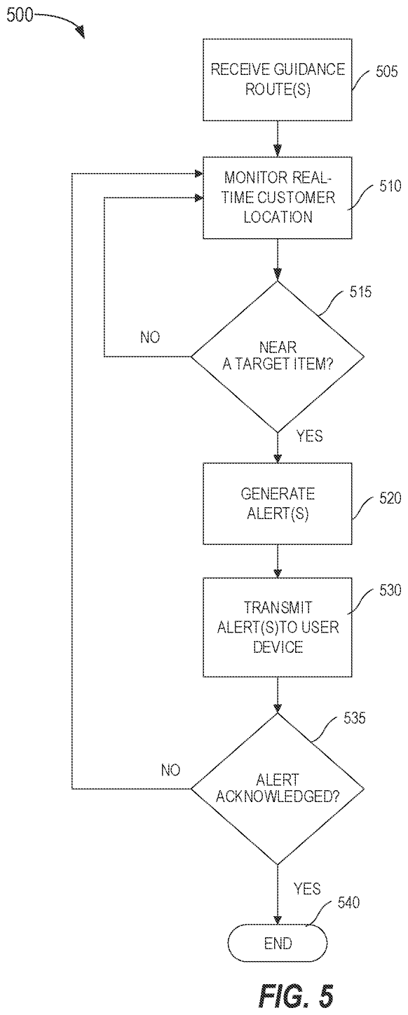

FIG. 5 depicts an example method 500 for alert generation, according to some embodiments of the present disclosure. In some embodiments, the method 500 may be performed by one or more computing devices, such as the server 110 as illustrated in FIG. 1, the alert generation component 275 as illustrated in FIG. 2, and/or the computing device 700 as illustrated in FIG. 7.

The method 500 begins at block 505, where a computing system (e.g., 275 of FIG. 2) receives guidance routes. In some embodiments, the guidance route may be generated based on the internal maps of the store and/or the locations of in-store items that match or are similar to the digital media items (e.g., those recognized by processing the digital media input). In some embodiments, the guidance routes may direct the customer to find the identified in-store items (also referred to in some embodiments as target items). In some embodiments, the guidance routes may highlight the shortest-distance path or the most convenient path from the customer's current location to these identified in-store items.

At block 510, the computing system monitors and tracks the customer's real-time location within the store.

At block 515, the computing system evaluates whether the customer is in close proximity to one of the identified in-store items (also referred to in some embodiments as target items). In some embodiments, the evaluation may involve a continuous check of the spatial relationship between the customer's real-time location and the location of the target item. In some embodiments, the system may define a distance threshold (e.g., 2 meters) for the evaluation. If the computed distance between the customer and the target item is less than or equal to the distance threshold (e.g., 10 meters), the system determines that the customer is near the target item, and the method 500 proceeds to block 520. If the computed distance is above the threshold, which indicates that the customer is not sufficiently close to the target item, the system returns to block 510, where the system continues to tracking the customer's locations and movements within the store.

At block 520, the computing system generates alerts to notify the customer about the item of interest. The alerts may include details about the target item, such as its name, descriptions, available color and size, and the like.

At block 525, the computing system transmits the alerts to a user device (e.g., 140 of FIG. 1). In some embodiments, the alerts may be transmitted to an in-store device (e.g., 135 of FIG. 1).

At block 530, the computing system checks if the alerts have been acknowledged by a customer (through a user device or an in-store device). If the alerts have been acknowledged, the method proceeds to block 540, where the alert generation process ends. If the alerts have not been acknowledged by the customer, such as when the customer is near the target item but has not successfully found it, the method 500 returns to block 510, where the computing system continues to track the customer's location and/or calculate the spatial distance between the customer and the target item in real time.

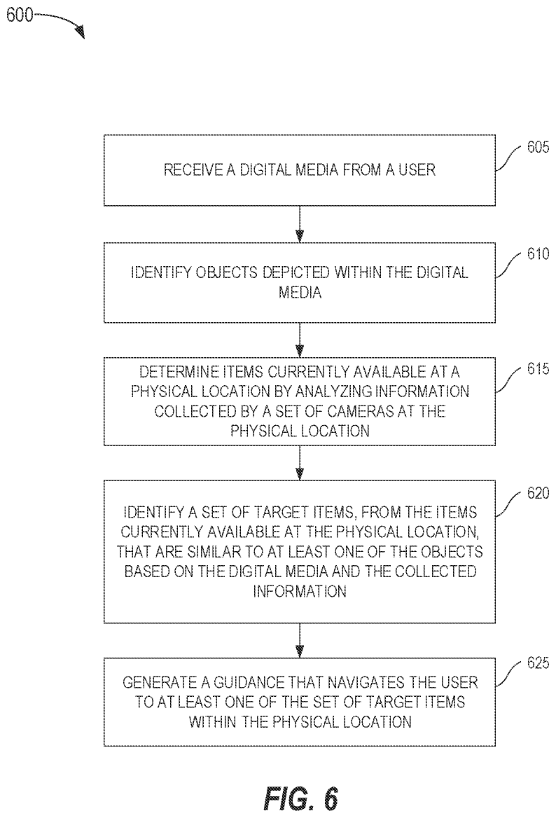

FIG. 6 is a flow diagram depicting an example method 600 for identifying in-store items similar to featured objects in digital media and generating a corresponding guidance route, according to some embodiments of the present disclosure.

At block 605, a computing system (e.g., 110 of FIG. 1) receives a digital media (e.g., 210 of FIG. 2) from a user. In some embodiments, the process of receiving the digital media may comprise scanning, by a device associated with the physical location (e.g., in-store devices 135 of FIG. 2), the digital media displayed on a device of the user (e.g., 140 of FIG. 1). In some embodiments, the device located at the physical location comprises a scanning camera.

At block 610, the computing system identifies objects (e.g., digital media items 225 of FIG. 2) depicted within the digital media.

At block 615, the computing system determines items currently available at a physical location (e.g., in-store items 240 of FIG. 2) by analyzing information collected by a set of cameras at the physical location (e.g., 225 of FIG. 2).

At block 620, the computing system identifies a set of target items (e.g., matching results 250 of FIG. 2), from the items currently available at the physical location, that are similar to at least one of the objects based on the digital media and the collected information.

At block 625, the computing system generates a guidance (e.g., 260 of FIG. 2) that navigates the user to at least one of the set of target items within the physical location. In some embodiments, the guidance may be displayed on at least one of (i) a device associated with the physical location or (ii) a device of the user, and the guidance is displayed along with information related to at least one of the set of target items.

In some embodiments, the computing system may further monitor, via the set of cameras at the physical location, changes in status of the set of target items in real time, and update the guidance based on the changes (as depicted at block 325 of FIG. 3).

In some embodiments, the computing system may further access an inventory database to check inventory of at least one of the objects at one or more other physical locations, and provide an alternative purchase path to the user (as depicted at blocks 330 and 335 of FIG. 3).

In some embodiments, the set of cameras at the physical location may be configured with artificial intelligence-based algorithms to determine at least one of (i) a category or (ii) a quantity of each of the items currently available at the physical location.

In some embodiments, the set of target items may comprise at least one of (i) the currently available items that are same as at least one of the objects, (ii) the currently available items that are visually similar to at least one of the objects, or (iii) the currently available items that are functionally similar to at least one of the objects.

In some embodiments, the digital media may comprise at least one of an image, a video, a live stream, a three-dimensional model, or a motion graphic.

In some embodiments, the objects within the digital media may be identified by using one or more neural networks, where the one or more neural networks are trained using historical received digital media as inputs, and labeled product identifiers as target outputs, and the one or more neural networks learn to correlate features from each respective digital media of the historical received digital media to a respective product identifier of the labeled product identifiers.

In some embodiments, the computing system may further receive feedback from the user regarding an accuracy of the objects identified from the digital media, and refine the one or more neural networks based on the received feedback.

In some embodiments, the computing system may further transmit an alert to a device of the user when the use approaches a location of an item from the set of target items (as depicted at block 530 of FIG. 5).

FIG. 7 depicts an example computing device 700 for item recognition and guidance route generation, according to some embodiments of the present disclosure. Although depicted as a physical device, in some embodiments, the computing device 700 may be implemented using virtual device(s), and/or across a number of devices (e.g., in a cloud environment). The computing device 700 can be embodied as any computing device, such as the server 110, the user device 140, the in-store device 135, and the in-store cameras 130 as illustrated in FIG. 1.

As illustrated, the computing device 700 includes a CPU 705, memory 710, storage 715, one or more network interfaces 725, and one or more I/O interfaces 720. In the illustrated embodiment, the CPU 705 retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally included to be representative of a random access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 735 (such as keyboards, monitors, etc.) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

In the illustrated embodiment, the memory 710 includes a data processing component 750, an item matching component 755, a guidance generation component 760, a customer location detection component 765, and an alert generation component 770. Although depicted as a discrete component for conceptual clarity, in some embodiments, the operations of the depicted component (and others not illustrated) may be combined or distributed across any number of components. Further, although depicted as software residing in memory 710, in some embodiments, the operations of the depicted components (and others not illustrated) may be implemented using hardware, software, or a combination of hardware and software.

In the illustrated embodiment, the data processing component 750 may be configured to process various visual data. The visual data may include the data (e.g., digital media) that customers view online, and the inventory visual data captured by in-store cameras. In some embodiments, the data processing component 750 may extract features by processing the visual data. In some embodiments, after these features are identified, the component may perform item recognition using trained ML models. In some embodiments, such as when the visual data is digital media received from customers (e.g., through in-store devices), the output of the data processing component may be a structured dataset of items featured within the digital media (also referred to in some embodiments as digital media items) and their respective attributes or characteristics. In some embodiments, such as when the visual data is received from in-store cameras, the output may be a real-time inventory dataset, which details the available products within the store (also referred to in some embodiments as in-store items) and their relevant attributes (e.g., color, size, brand, quantity, and location).

In the illustrated embodiment, the item matching component 755 may determine the similarities between in-store items and the digital media items. In some embodiments, the item matching component 755 may represent each item as a feature vector based on the item's attributes and features. The vector captures the essence of an item, and projects its diverse characteristics into a multi-dimensional space. To evaluate the similarity between in-store items and digital media items, the item matching component 755 may compute metrics like the cosine similarity or Euclidean distance between the respective vectors of these items. The metrics may quantify the relationship between the items in the multi-dimensional space. For example, in some embodiments, an exact match between an in-store item and a digital media item may be identified when the distance metric is zero. In some embodiments, two items may be determined to be similar when the distance metric between these items satisfies certain criteria. For example, items may be considered similar if the cosine similarity between their vectors exceeds a defined threshold or if the Euclidean distance between their vectors falls below a defined threshold. The output of the item matching component may be a list of in-store items that match or are similar to the digital media items (also referred to in some embodiments as target items) and their relevant attributes (e.g., color, size, brand, quantity, and location).

In the illustrated embodiment, the guidance generation component 760 may be configured to generate guidance routes to direct the customer to find these target items. In the illustrated embodiments, the customer location detection component 765 may collect the customer's real-time location within the store. In the illustrated example, the alert generation component 770 may receive the guidance routes for target items from the guidance generation component 760, and collect the customer's real-time location data from the customer location detection component 765. Based on the received data, the alert generation component 770 may calculate the spatial distance between the customer and each of the target items. The alert generation component 770 may generate an alert upon determining that the distance between the customer and any target item falls below a defined threshold. The alert may notify the customer of the proximity of an item of interest.

In the illustrated example, the storage 715 may include digital media records 775, inventory data 780, and alert records 785. In some embodiments, the aforementioned data may be saved in a remote database (e.g., 125 of FIG. 1) that connects to the computing device 700 via a network (e.g., 105 of FIG. 1).

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to the described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications (e.g., item searching application) or related data available in the cloud. For example, the item searching application could that performs the item recognition and matching through a cloud computing infrastructure, and store the relevant data in a storage location in the cloud. Doing so allows a user to access this information from any computing system attached to a network connected to the cloud (e.g., the Internet).

While the foregoing is directed to embodiments of the present disclosure, other and further embodiments of the disclosure may be devised without departing from the basic scope thereof, and the scope thereof is determined by the claims that follow.

What is claimed is:

1. A method comprising:
receiving a digital media from a user;
identifying objects depicted within the digital media;
determining items currently available at a physical location by analyzing information collected by a set of cameras at the physical location;
identifying a set of target items, from the items currently available at the physical location, that are similar to at least one of the objects based on the digital media and the collected information; and
generating a guidance that navigates the user to at least one of the set of target items within the physical location.

2. The method of claim 1, wherein the guidance is displayed on at least one of (i) a device associated with the physical location or (ii) a device of the user, and the guidance is displayed along with information related to at least one of the set of target items.

3. The method of claim 1, further comprising:
monitoring, via the set of cameras at the physical location, changes in status of at least one of the set of target items in real time, and
updating the guidance based on the changes.

4. The method of claim 1, further comprising:
accessing an inventory database to check inventory of at least one of the objects at one or more other physical locations; and
providing an alternative purchase path to the user.

5. The method of claim 1, wherein the set of cameras at the physical location are configured with artificial intelligence-based algorithms to determine at least one of (i) a category or (ii) a quantity of each of the items currently available at the physical location.

6. The method of claim 1, wherein the set of target items comprises at least one of (i) the currently available items that are same as at least one of the objects, (ii) the currently available items that are visually similar to at least one of the objects, or (iii) the currently available items that are functionally similar to at least one of the objects.

7. The method of claim 1, wherein the digital media may comprise at least one of an image, a video, a live stream, a three-dimensional model, or a motion graphic.

8. The method of claim 1, wherein:
the objects within the digital media are identified by using one or more neural networks,
the one or more neural networks are trained using historical received digital media as inputs, and labeled product identifiers as target outputs, and
the one or more neural networks learn to correlate features from each respective digital media of the historical received digital media to a respective product identifier of the labeled product identifiers.

9. The method of claim 8, further comprising:
receiving feedback from the user regarding an accuracy of the objects identified from the digital media; and
refining the one or more neural networks based on the received feedback.

10. The method of claim 1, further comprising transmitting an alert to a device of the user when the use approaches a location of an item from the set of target items.

11. The method of claim 1, wherein receiving the digital media from the user comprises scanning, by a device associated with the physical location, the digital media displayed on a device of the user, and wherein the device located at the physical location comprises a scanning camera.

12. A system comprising:
one or more memories collectively storing computer-executable instructions; and
one or more processors configured to collectively execute the computer-executable instructions and cause the system to:
receive a digital media from a user;
identify objects depicted within the digital media;
determine items currently available at a physical location by analyzing information collected by a set of cameras at the physical location;
identify a set of target items, from the items currently available at the physical location, that are similar to at least one of the objects based on the digital media and the collected information; and
generate a guidance that navigates the user to at least one of the set of target items within the physical location.

13. The system of claim 12, wherein the guidance is displayed on at least one of (i) a device associated with the physical location or (ii) a device from the user, and the guidance is displayed along with information related to at least one of the set of target items.

14. The system of claim 12, wherein the one or more processors configured to collectively execute the computer-executable instructions and cause the system to further:
monitor, via the set of cameras at the physical location, changes in status of at least one of the set of target items in real time, and
update the guidance based on the changes.

15. The system of claim 12, wherein the one or more processors configured to collectively execute the computer-executable instructions and cause the system to further:
access an inventory database to check inventory of at least one of the objects at one or more other physical locations; and
provide an alternative purchase path to the user.

16. The system of claim 12, wherein the set of cameras at the physical location are configured with artificial intelligence-based algorithms to determine at least one of (i) a category or (ii) a quantity of each of the items currently available at the physical location.

17. The system of claim 12, wherein the set of target items comprises at least one of (i) the currently available items that are same as at least one of the objects, (ii) the currently available items that are visually similar to at least one of the objects, or (iii) the currently available items that are functionally similar to at least one of the objects.

18. The system of claim 12, wherein the digital media may comprise at least one of an image, a video, a live stream, a three-dimensional model, or a motion graphic.

19. The system of claim 12, wherein:
the objects within the digital media are identified by using one or more neural networks,
the one or more neural networks are trained using historical received digital media as inputs, and labeled product identifiers as target outputs, and
the one or more neural networks learn to correlate features from each respective digital media of the historical received digital media to a respective product identifier of the labeled product identifiers.

20. One or more non-transitory computer readable media containing, in any combination, computer program code that, when executed by operation of a computing system, performs operations comprising:
receiving a digital media from a user;
identifying objects depicted within the digital media;
determining items currently available at a physical location by analyzing information collected by a set of cameras at the physical location;
identifying a set of target items, from the items currently available at the physical location, that are similar to at least one of the objects based on the digital media and the collected information; and
generating a guidance that navigates the user to at least one of the set of target items within the physical location.
